(19) United States
(12) Patent Application Publication
(10) Pub. No.: US 2007/0028512 A1
(43) Pub. Date: Feb. 8, 2007

(54) Modular greenhouse system

(76) Inventor: Thomas M. McGhee, Fresno, CA (US)

Correspondence Address: Ronald B. Sefrna, P.O. Box 567, Tyler, TX, 75710, US

(21) Appl. No.: 11/455,267

(22) Filed: Jun. 19, 2006

Related U.S. Application Data
(60) Provisional application No. 60/706,185, filed on Aug. 8, 2005.

(51) Int. Cl. A01G 9/00

(52) U.S. Cl. 47/17

(57) ABSTRACT

A modular construction system for forming a greenhouse structure includes a plurality of glazing panels and a plurality of support members for connecting and supporting the glazing panels. In the preferred embodiment the glazing panels and support members are connected utilizing interlock brackets connected to and extending outwardly from the edges of the glazing panels, to form a positive interlock between glazing panels and support members. A bypass sliding ventilation window assembly is provided, and a bypass sliding door assembly, or alternatively a hinged door assembly, is also provided. At least one glazing panel or sliding ventilation window panel preferably includes a self-sealing pass-through aperture for an electric cord or the like.

### RELATED APPLICATION DATA

This application claims the benefit of U.S. Provisional Patent Application Ser. No. 60/706,185, filed Aug. 8, 2005, titled “Modular Greenhouse System”.

### FIELD OF THE INVENTION

The present invention generally relates to enclosures for the protection and nurturing of plants, e.g., greenhouses, and in its preferred embodiments more specifically relates to a modular greenhouse system formed of support members and panels that can be connected in a variety of configurations to form structures of different dimensions and capacities.

### BACKGROUND

Conventional, fixed location greenhouses are well known and have long been used to protect plants and allow growers to create conditions particularly suited for specific types of plants. Commercial growers often use large fixed greenhouse structures to start plants from seeds or cuttings earlier in the growing season than would be possible without protection. Greenhouses are also commonly used for the seasonal protection of plants grown in movable containers, so that, e.g., tropical plants that would not survive winters in the location where they are grown can be moved into greenhouse structures for protection during the winter season. Many individuals use greenhouses for this purpose.

Although a greenhouse is effective in protecting plants during cold seasons, there are disadvantages and drawbacks to this approach. A conventional fixed greenhouse occupies a significant space and can consume a substantial portion of, e.g., a homeowner's yard or garden area. If the greenhouse is used only for season protection it remains vacant during the remainder of the year and the garden space it occupies is unused. Further, such greenhouses cannot provide protection for plants permanently planted in the ground around a grower's property, because those plants cannot be moved into a greenhouse. The same problem exists with large container grown plants, when the weight of the plants, container, and soil prohibits moving them. The only solution available for growers of such plants, in the ground and/or in containers, is to cover the plants during cold temperatures or to construct a makeshift enclosure around them during the winter. Simply covering plants is often not effective when the outside temperature drops significantly below the plant's minimum tolerable temperature, especially for an extended period. Wind may blow covers off the plants or disturb them enough to allow outside air to enter and damage the plant. Constructing makeshift substantial enclosures around the plants is also a less than desirable solution. Such enclosure are not only typically very unattractive, they may not be sufficiently sturdy to serve through an entire season without frequent repair. More substantial enclosures can be expensive and time consuming to build, and then remove when the season changes and the plants can survive without protection.

Portable or temporary greenhouses or protective enclosures are known in the prior art and are commercially available. Prefabricated greenhouse kits are also known and available. However, these enclosures are generally available only in certain standard sizes and configurations that are often not suitable for at least some plants a grower wishes to protect.

There remains a need for a truly modular greenhouse system that can be easily assembled by a person without building or construction skills, that can be used to provide greenhouse or protective enclosures in a wide variety of sizes and configurations, that provides easy access to the interior of the structure, that can be easily heated as needed, that can be easily disassembled after use, and that can be easily and compactly stored for subsequent use.

### SUMMARY OF THE INVENTION

The present invention provides such a modular greenhouse system comprised of standardized components. The construction system of the invention allows a user to easily and quick assembly a greenhouse structure for use, and to easily and quickly disassemble the structure for storage when not needed for plant protection. The primary components include glazing panels for forming the walls of a greenhouse structure and support members for connecting and supporting the glazing panels. It is preferred that the glazing panels and support members be connected in an interlocking relationship, using interlock brackets connected to the glazing panels, with an interlock extension to be received in an interlock groove formed in the support members. Additional components, including sliding or hinged door assemblies and a sliding ventilation window assembly, are also provided.

The objectives to be achieved by the invention are apparent from the foregoing background and the following description, in which the components and structure of the system of the invention will be described in detail with reference to the accompanying drawing figures.

### BRIEF DESCRIPTION OF THE DRAWINGS

FIG. 1 is a perspective view of an assembled basic module of an enclosure in accordance with the invention

FIG. 2 is a perspective view of an assembled module of an enclosure with a variation to provide a sliding top panel.

FIG. 3 is a plan view of a wall panel or top panel of the preferred embodiment of the invention.

FIG. 4 is a top edge view of a wall panel of the preferred embodiment, of single wall construction.

FIG. 5 is a top edge view of a wall panel of the preferred embodiment, of double wall construction.

FIG. 6 is a top view of a support member component of the preferred embodiment, with the preferred form of interlock groove formed in all four faces.

FIG. 7 is a top view of an alternative embodiment of a support member component, with an alternative form of interlock groove in two adjacent faces.

FIG. 8 is a side elevation view of a first support member.

FIG. 9 is a side elevation view of a second support member.

FIG. 10 is a partially cut away corner view of an enclosure in accordance with the invention, showing attachment plates for connecting support members.

FIG. 11 is a partially cut away corner view of an enclosure in accordance with the invention, showing an alternative connection for support members.

FIG. 12 is an elevation view of a portion of a glazing panel or a window panel with a pass-through aperture, with a first embodiment of an aperture seal, partially cut away to show the aperture.

FIG. 13 is an elevation view of a portion of a glazing panel or a window panel with a pass-through aperture, with a second embodiment of an aperture seal, partially cut away to show the aperture.

FIG. 14 is a perspective view of a preferred embodiment of an enclosure in accordance with the invention, including sliding ventilation panels and sliding door panels.

FIG. 15 is a perspective view of a preferred embodiment of an enclosure in accordance with the invention, including sliding ventilation panels and hinged door panels.

FIG. 16 is an edge view of a sliding panel structure (spacing exaggerated for clarity).

FIG. 17 is a partially cut away elevation view of a hinged door panel structure.

FIG. 18 is an elevation view of a composite wall structure formed from a plurality of wall panels and support members.

### DESCRIPTION OF THE INVENTION

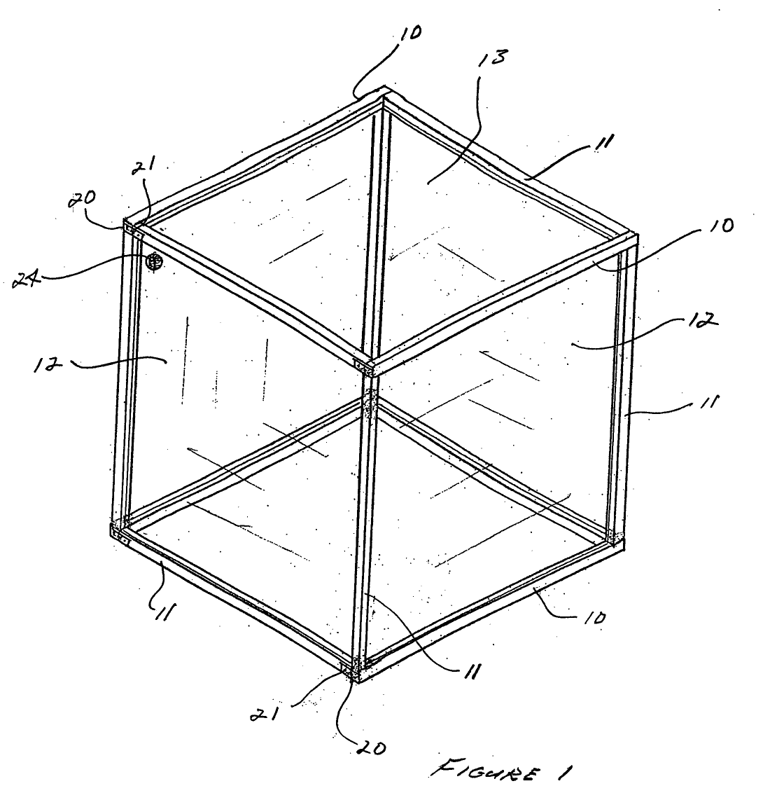

A basic module of the preferred embodiment of the greenhouse system of the invention, shown in FIG. 1, is in the form of a cubical structure including four first support members 10, and eight second support members 11, with five glazing panels, four of which are used as wall panels 12, and the fifth of which is used to form a top panel 13. In the preferred embodiment the base or bottom face of the cubical structure is open, so that the structure can be placed over a plant with the bottom edges of the structure received against the ground or other horizontal surface.

The modular greenhouses of the invention are designed to be easily assembled for use, and disassembled for storage, by a typical homeowner using, at most, only simple household tools. It is contemplated that the greenhouse components will be provided disassembled, in the form of a kit, to minimize inventory storage space and facilitate transportation.

Wall panels 12 and top panel 13 are rectangular and of equal size, with a height “h” between top and bottom edges and a width “w” between first and second side edges. In the preferred embodiment the wall panels and top panel are square, so that dimension “h” and dimension “w” are the same, but the scope of the invention is not limited to square panels.

Support members 10 and 11 are preferably square in cross-sectional configuration, and are all of the same cross-sectional dimensions. In the preferred embodiment the support members are square in cross-sectional configuration, of the same thickness, “t”, between opposite faces. The preferred thickness is nominally two inches, but the scope of the invention is not limited to any particular dimensions. First support members 10 are of equal length, 1₁₀, which is equal to the height (h) of the wall panels plus twice the support member thickness. Second support members 11 are also of equal length, 1₁₁, which in the preferred embodiment is equal to the width (w) of the wall panels. As algebraic expressions,
1₁₀=h+2t
1₁₁=w
For square wall and top panels, the lengths of the support members may be expressed as
1₁₀=1₁₁+2t
In a particularly preferred embodiment the components are dimensioned to provide a cubical enclosure module approximately four feet on each side. It is to be understood, however, that the scope of the invention is by no means limited or restricted to any specific component dimensions, and that essentially any component dimensions may be used.

The basic module of the greenhouse system is assembled with the support members forming the twelve edges of the structure, and with the panels interconnected between the support members to form five of the six faces of the structure, with the sixth face left open in the preferred embodiment. In a greenhouse structure intended to protect a plant or plants from cold, the structure should be well sealed. In the preferred embodiments of the structure of the invention the edges of each of the wall panels and of the top panel are interlocked with the adjacent support members, to seal the connections between the panels and the support members, and to assure the stability of the assembled greenhouse structure.

Accordingly, support members 10 and 11 are preferably formed with an interlock groove 14 extending into the support members from each face of each support member, generally centered between the edges of each face and extending the full length of the support member. For the assembly of a single module the interlock grooves 14 are required only in two, adjacent, faces of each support member, but are preferably provided in all four faces of the support members to facilitate assembly and to allow the expansion of the basic module to a larger structure, as described below. In a basic embodiment of the interlock system, grooves 14 are simple slot-like grooves, and the interlock is formed by extending edges 15 of the glazing panels 12 and 13 into the interlock grooves, as illustrated in Figure X. In this embodiment the length of second support members 11 is reduced by twice the depth “d” of grooves 14, rather than being equal to the width “w” of the glazing panels, or, algebraically, 1₁₁=w−2d, so that glazing panel edges extend beyond the ends of the second support members to be received in the groove in first support members.

A more secure interlock is preferred, however, and in the preferred embodiment a male dovetail-type interlock extension 16 is provided along the majority of the length of each edge 15 of each wall panel 12 and each top panel 13. It is preferred that the panels be formed of a generally rigid plastic material such as acrylic or polycarbonate, or of glass, and although it is technically feasible to form the interlock extensions as integral parts of the panels, it is preferred that interlock brackets 17, with a generally U-shaped recess 18 to receive an edge 15 of a panel and with interlock extension 16 extending outwardly therefrom, be attached to each edge of each panel using a compatible adhesive material or other conventional means of attachment. However they are formed and attached to the panels, the interlock extensions do not extend fully along each edge, but stop short of each corner to provide clearance for engagement of adjacent support members.

It is preferred that panels 12 and 13 be square, with the height “h” of each panel equal to the width “w” of the panel. In that embodiment all interlock brackets 17 are of the same length. However, in an embodiment in which panels 12 and 13 are rectangular, of unequal height and width, first and second interlock brackets, 17h and 17w are used, interconnected to the first and second side edges, and to the top and bottom edges, respectively.

In the preferred embodiment, an undercut dovetail-type interlock groove 18 is formed in each face of each support member instead of the simple slot-like grooves 14. As noted above, interlock grooves 18 are preferably provided in all four faces of the support members. With the preferred embodiment of the interlock connections, support members are connected to the wall panels or to the top panel by engaging one end of an interlock extension 17 in one end of an interlock groove 18 of a support member and sliding the panel and support member together to fully engage the interlock. To provide clearance for the sliding engagement of support members and panels during assembly of the structure and to facilitate the assembly procedure, the length of each interlock bracket 17 is preferably shorter than the length of the respective glazing panel edge to which it is attached by approximately the thickness “t” of the support members. Because in this embodiment the interlock brackets extend outwardly from edges 15 of the glazing panels, the length of second support members 11 is not reduced, and is equal to the width “w” of the glazing panels as described above for the preferred embodiment of the support members.

The basic module of the greenhouse is assembled by sequentially connecting support members and panels to form the enclosure. Although the interlocks between the panels and the support members connect the components provide a reasonable level of integrity to the structure, a greater degree of strength and rigidity can be achieved, and it is preferred, that the support members be connected to each other during the assembly with connector plates 20. In the preferred embodiment plates 20 are flat plates of sufficient length to overlap intersecting support members, preferably at least twice the thickness “t” of the support members, and are connected to the support members by extending screws 21 through apertures 22 in the plates. Alternatively, right angle connector brackets 23 can be used in lieu of plates 20, to span a corner of the enclosure and connect two horizontally disposed support members and one upright support member with each bracket 23.

Once the enclosure is assembled it can be placed over a plant or a grouping of plants, either growing in the ground or in pots or other containers, with the lower edge of the enclosure resting upon the ground or on a flat surface upon which the containers are placed. Alternatively, the enclosure can be assembled around a plant or group of plants, eliminating any need to lift and move the assembled enclosure.

In the preferred embodiment one or more pass-through apertures 24 are provided at a corner or in a cut-out in at least one of panels 12, to provide a passageway for, e.g., an electric heater cord or light cord into the interior of the enclosure. Apertures 24 may be of any convenient configuration, such as rectangular or circular. To avoid heat loss from the enclosure, apertures 24 preferably include a sealing means to seal around a cord or the like extended through the aperture and to close the aperture when the cord is removed. In one approach a grommet 25 is connected around the aperture edge, with a web 26 of flexible shape-retentive material extending across the opening aperture 24. A slit 27, or plurality of slits, is formed in web 26, to allow a cord or the like to be pushed through the slit. Web 26 will close around the object, and will close fully when the object is removed, to minimize air movement through aperture 24.

In another approach a brush seal 28 may be used instead of, or in addition to, web 26. A plurality of closely spaced bristles 29 extend across aperture 24 and intermingle with each other to the bristles, which will deform to allow passage and then close around the object to seal. Aperture 24 could also be provided with a cover, if desired, to assure closure of the aperture when not in use.

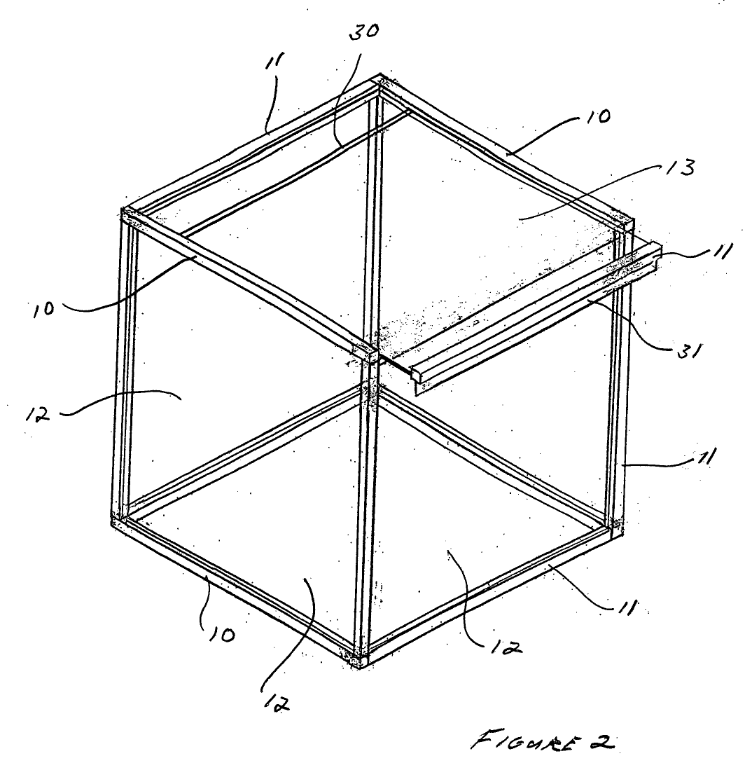

The enclosure can be assembled with an interlock connection between each edge of each panel and each support member, through a specific sequence of assembly steps. Assembly can be facilitated with an alternative embodiment of the basic module, illustrated in FIG. 2, in which the male interlock extension 16 (or the interlock bracket 17) is omitted from one edge of, e.g., the top panel 13, so that the top panel can be slid into interlocked connection with support members along the adjacent sides of the panel. A first support member 10 can then be slid into interlocking connection with the open edges of the, e.g., top panel and the adjacent perpendicular wall panel. The edge of the panel without the interlock extension is butted against the face of the support member against which it is brought to rest, or alternatively, a straight sealing extension 30 may be provided along one edge of that panel instead of an interlock extension 16, so that the extension can be inserted into an interlock groove 19 from the face of the panel. An interlock connection is not formed between that panel edge and the support member, but the edge of the panel is fully supported along the length of the support member, and an effective seal against air movement between the panel edge and the support member is maintained.

The interlock extension 16 may also be omitted from the upper edge of the wall panel 12 over which the top panel 13 is slid during assembly of this alternative embodiment. In this embodiment first support members 10 are disposed vertically when the enclosure is positioned for use, with second support members 11 disposed horizontally. A second support member may be interlocked with the edge of the top panel opposite the edge from which the interlock extension is omitted, so that when the top panel is slid into position to close the top of the enclosure that support member is brought into overlying relation with the edge of the wall panel from which the interlock extension is omitted. If desired, a sealing strip 31, with an interlock extension 16 to be anchored in an interlock groove 19 of that second support member, so that the strip is received against the edge portion of the wall panel when the top panel is fully inserted. The ends of that second support member are received between, or against, the adjacent first support members of the enclosure (depending on how the support members are assembled) when the top panel is fully inserted. That second support member can then be connected to the adjacent first support members, if desired, to close and seal the enclosure. However, if that second support member is left free of connection to the adjacent first support members, or is releasably connected, the top panel can be easily moved back and forth along the interlock connections at its side edges, allowing the top of the enclosure to be opened for ventilation and/or for access to the plant(s) in the enclosure for watering or other care without moving the entire enclosure.

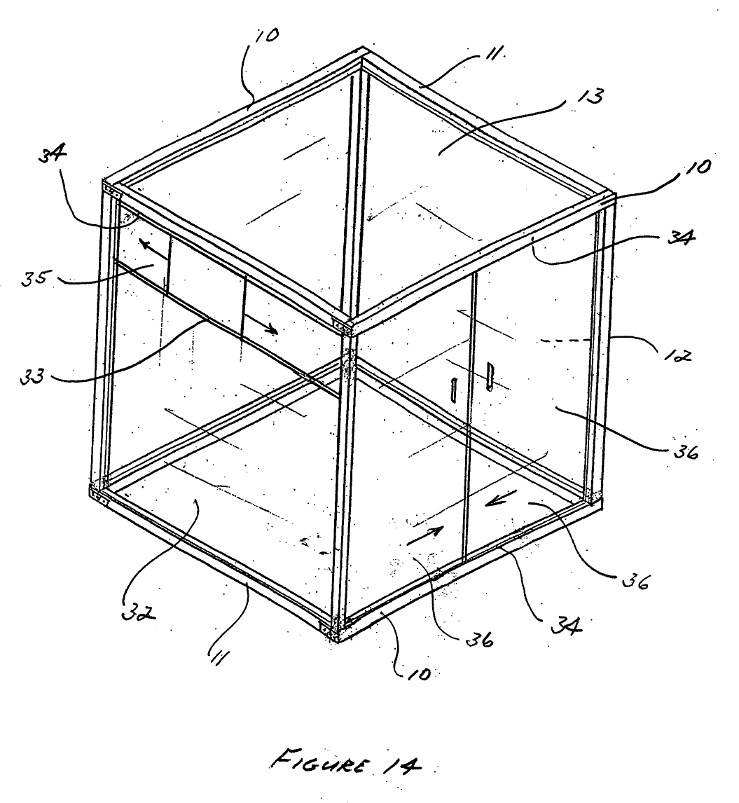

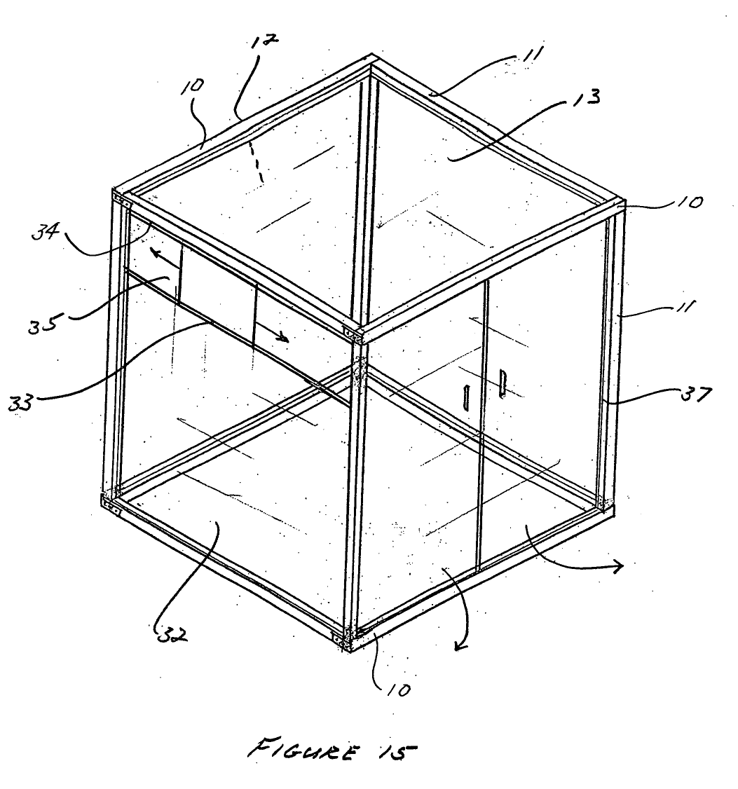

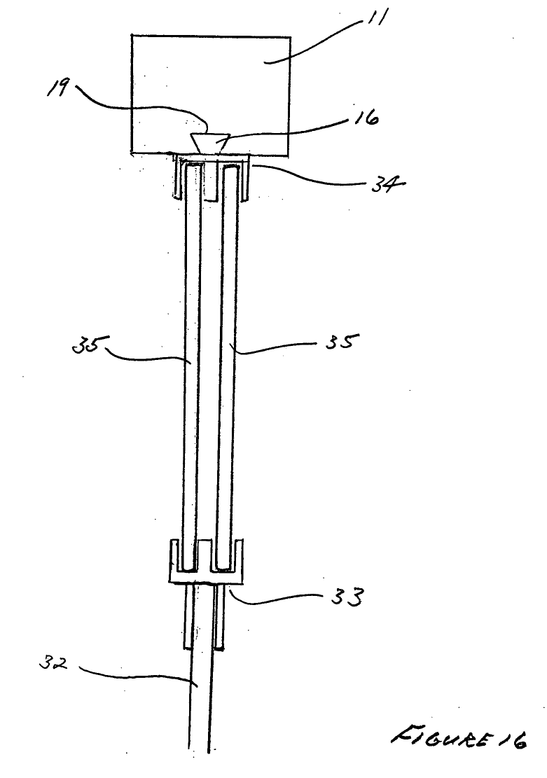

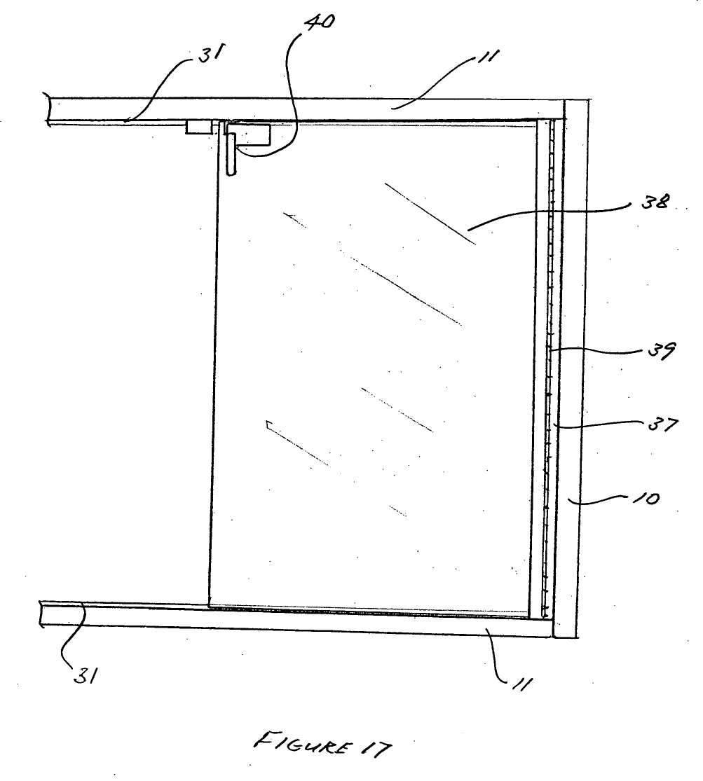

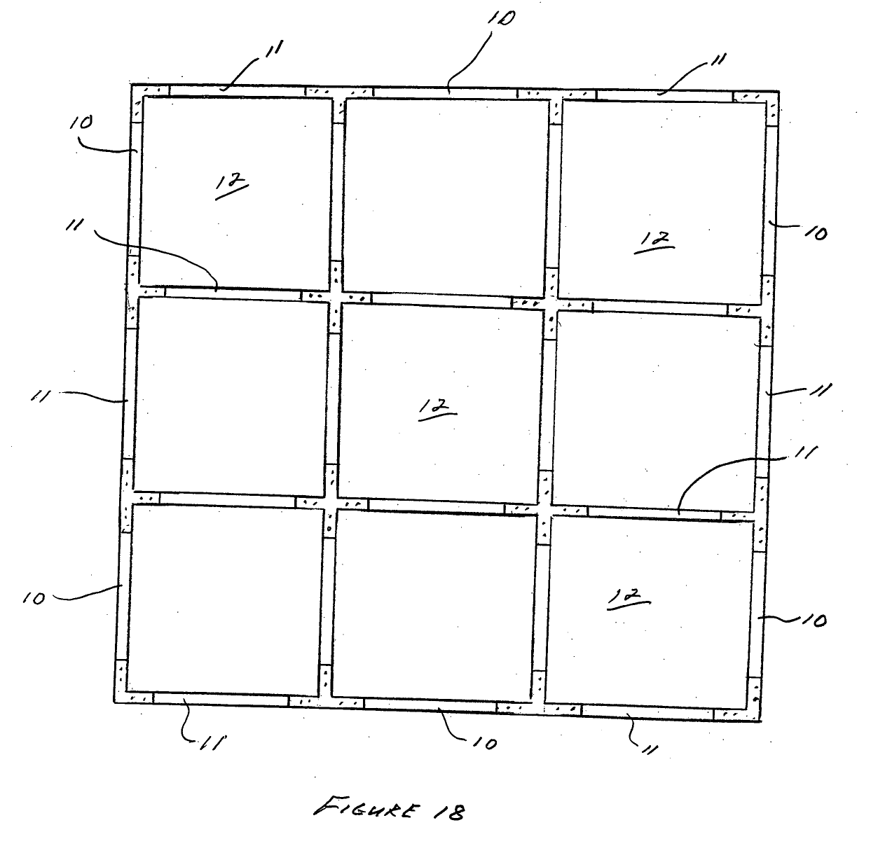

The components of the basic module of the greenhouse system of the invention can also be used to form larger structures or enclosures. A series of wall panels 12, can be connected parallel to each other, using the first and second support members, to connect and support the wall panels, the support members themselves connected by plates or brackets, to form a wall of essentially any desired height and width increments. Such a wall structure is illustrated in FIG. 11. As non-limiting examples, such wall sections can be interconnected to form a fully enclosed structure of greater height, greater width, and/or greater depth than the basic five panel module described above. Wall sections can also be connected to form a three wall structure to be placed against, e.g., an existing exterior building wall, or to form a two wall structure to be placed in an inside corner formed by intersecting building walls. As with the basic five panel module, such structures can be easily assembled for use when needed, and disassembled for storage when not needed.

The system of the invention is also readily amenable to adaptations related to ventilation and access to the interior of the enclosure. In an embodiment with the addition of by-pass sliding ventilation, or window, panels at the upper portion of one or more of the walls of the enclosure, at least one wall panel 12 is replaced by a shorter glazing panel 32. Interlock extensions 16 are provided along the bottom edge and two side edges of panel 32, as with panels 12. A two channel slider bracket 33 is connected to the remaining, upper edge of panel 32, and a two channel slider bracket 34, with an interlock extension 16 is provided to be inserted into the interlock groove 19 of the support member that will form the top edge of the assembled enclosure over panel 32. A pair of ventilation panels 35 are placed in parallel relation between slider bracket 33 and slider bracket 34, with a ventilation panel in each of the channels of those brackets, so that the ventilation panels can slide past each other in their respective channels. Each ventilation panel extends at least slightly more than half the distance across the upper edge of panel 32, so that the ventilation panels can be positioned to fully span and close the space above panel 32, or moved to more fully overlap each other and partially open the space above panel 32. If desired, panel 32 and ventilation panels 35 can be inverted, so that the adjustable opening is disposed at the bottom of the panel. Two panels 32 and two sets of ventilation panels 35 can be installed, with one inverted relative to the other, to provide cross ventilation through the interior of the assembled structure. Ventilation panels 35 can also be opened only slightly, to provide an access port for, e.g., an electrical cord to a heater or light, or for irrigation tubing. A pass-through aperture 24, described above, may also be provided in one of panels 35. With an aperture 24 disposed near one end of a panel 35, the by-passing panels can be positioned so that the end of one panel overlaps the aperture 24 in the other panel, providing a cover for the aperture.

In another embodiment doors can be provided for side access to the interior of the enclosure. A set of bypass sliding doors can be provided in place of a wall panel 12 through a variation of the ventilation panel structure described above. In this embodiment two slider brackets 34 are used, each being equal in length to the extension brackets with one interlocked with the structural member at the top edge of the enclosure, above the door opening, and with the second interlocked with the structural member at the lower edge of the enclosure, below the door opening. A pair of door panels 36 are placed in parallel relation between the upper slider bracket 34 and the lower slider bracket 34, with a door panel in each of the channels of those brackets, so that the door panels can slide past each other in their respective channels in the same manner as the ventilation panels. The width of each door panel is slightly greater than half the distance between the support members on the sides of the door space, so the door panels will overlap at their adjacent edges when full closed.

In another approach one or two hinged door panels may be used. In this embodiment, to provide a single hinged door, a hinge bracket 37 is connected between each door panel 38 and the vertical support member disposed at the hinged side of the door panel. Hinge bracket 37 includes a channel 18 to receive and connect the bracket to an edge of the door panel, an interlock extension 16 to be received in interlock groove 19 of the vertical support member, and hinge 39 disposed between channel 18 and interlock extension 16. Door panel 38 is dimensioned to fill the space between support members framing the door opening of the enclosure. A seal may be formed along the three un-hinged edges of door panel 38 to seal the door opening when door 38 is closed, using sealing strips 31 or other sealing means. A handle and latch means 40, using a magnetic catch or other suitable means, is preferably provided to secure door panel 38 in a closed position. If desired, double doors may be used instead of a single door panel, by providing a hinged door structure on each side of the door opening and using narrower door panels. Further, the hinged panel structure could be used for ventilation panels as well as for door panels, if desired, just as the sliding panel structure can be used for doors.

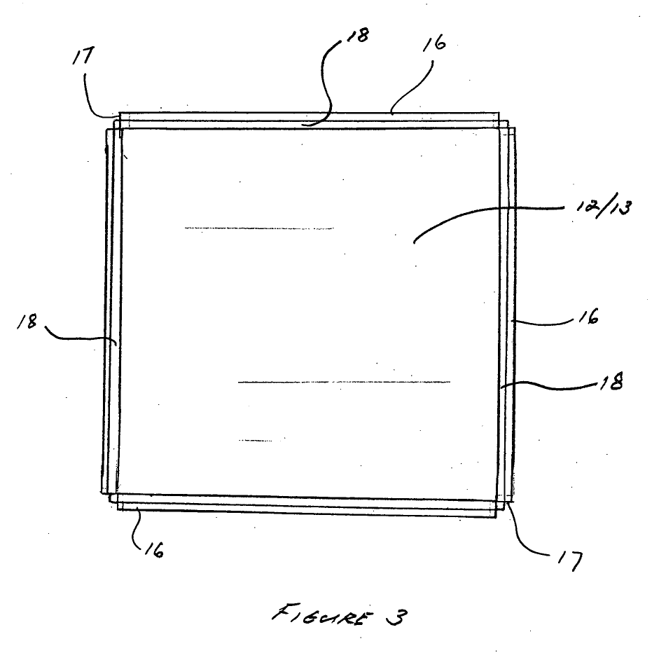

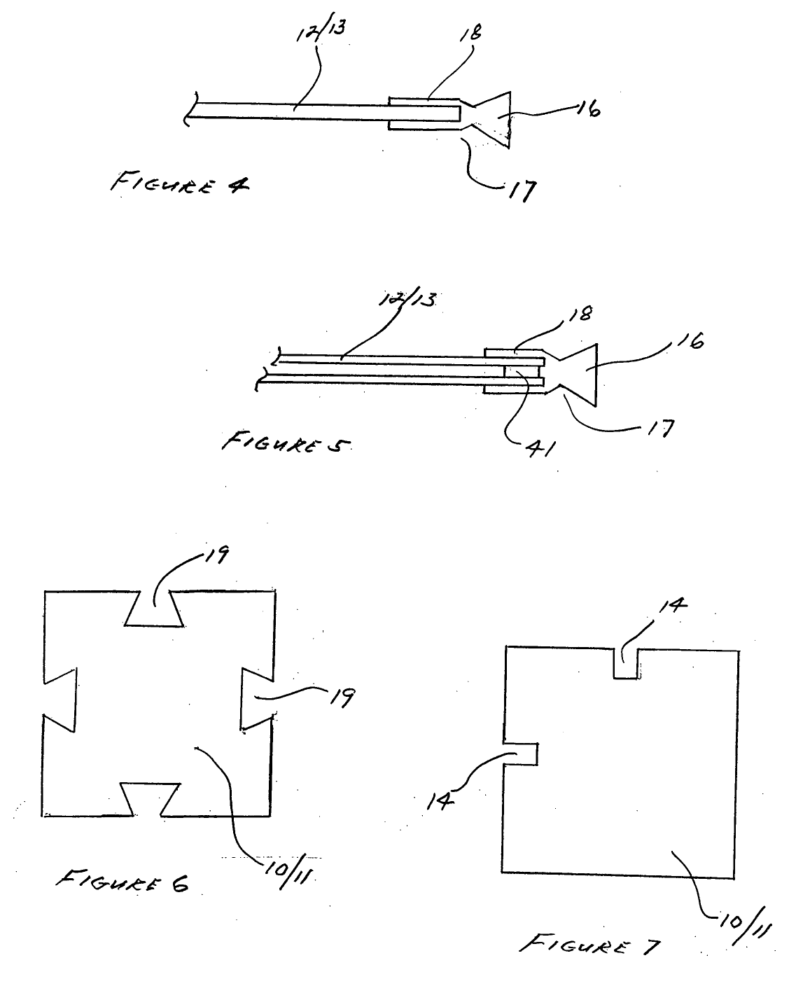

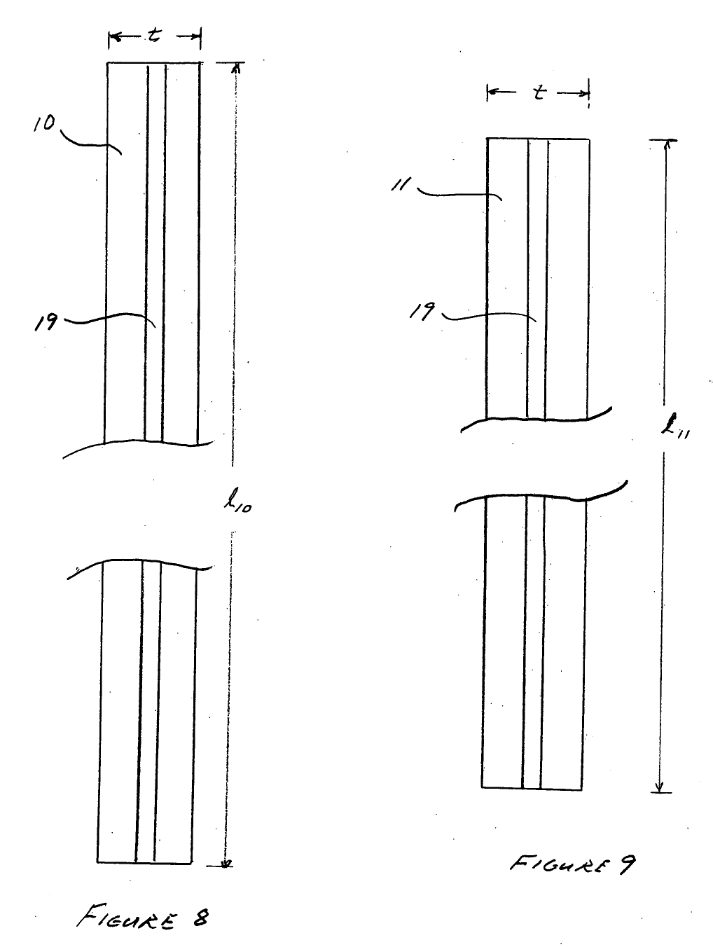

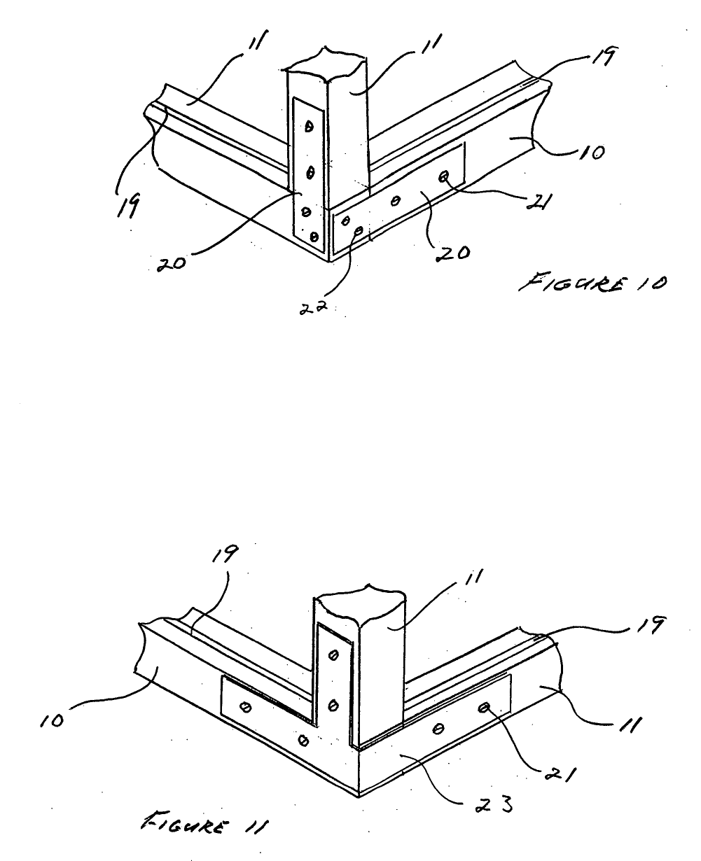

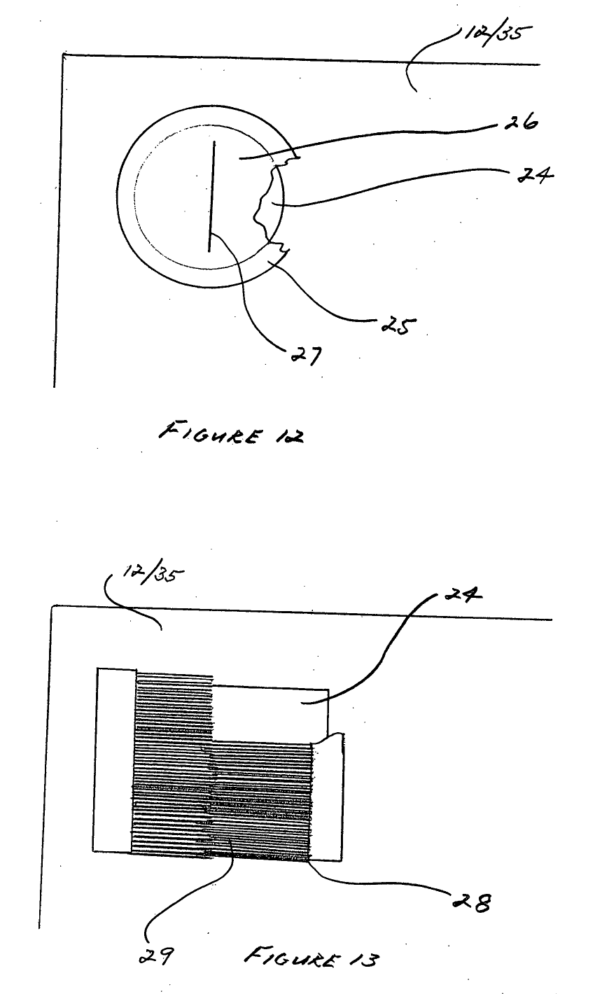

The components of the modular construction system of the invention are subject to a number of additional variations. As non-limiting examples, the glazing panels 12 and 13 may be of single pane construction, as shown in FIG. 4, or may be of double-pane construction, as shown in FIG. 5, to increase their insulating value. In the double pane construction two panes are disposed in parallel relation, separated by spacers 41 to provide an insulating space between the panes. In this variation the channels 18 in interlock brackets 17 are wider to accommodate the thicker panels.

The modular system of the invention allows an extremely wide variety of greenhouse structures and other enclosure structures to be formed from three basic components; support members 10 and 11, and panels 12, using a simple connection system of interlock brackets 17 and connection plates or brackets to assure the integrity of the assembled structures. The components can be transported and stored in small space, and easily assembled and disassembled by persons with only basic mechanical skills. Ventilation panels and/or door panels can be easily added to the basic structural module to accommodate an even wider variety of needs and desired uses.

The foregoing description is intended to be illustrative and not limiting. The system of the invention, and the described components, are susceptible to additional variations and alternative embodiments, all within the scope of the invention, as generally defined by the following claims.

1. A modular construction system for forming a greenhouse structure, comprising,
a plurality of planar glazing panels each having a first side edge, a second side edge opposite said first side edge, a top edge, and a bottom edge opposite said top edge, and each being of width “w” between said first and second side edges and of height “h” between said top edge and said bottom edge;
a plurality of first support members of square cross-sectional configuration, each having a first end and a second end, and having a first face, a second face adjacent to said first face, a third face opposite said first face, and a fourth face opposite said second face, each of said first support members being of thickness “t” between said first face and said third face and between said second face and said fourth face, each of said first support members being of a length equal to said height “h” of said glazing panels plus twice said thickness “t”, each of said first support members having a first longitudinal interlock groove extending into said first support member from said first face and extending through said length of said first support member equidistant between the intersection of said first face and said second face and the intersection of said first face and said third face, and a second interlock groove extending into said first support member from said second face and extending through said length of said first support member equidistant between the intersection of said second face and said first face and the intersection of said second face and said fourth face;
a plurality of second support members of square cross-sectional configuration, each having a first end and a second end, and having a first face, a second face adjacent to said first face, a third face opposite said first face, and a fourth face opposite said second face, each of said second support members being of thickness “t” between said first face and said third face and between said second face and said fourth face equal to said thickness of said first support members, each of said second support members being of a length equal to said width “w” of said glazing panels, each of said first support members having a first longitudinal interlock groove extending into said second support member from said first face and extending through said length of said second support member equidistant between the intersection of said first face and said second face and the intersection of said first face and said third face, and a second interlock groove extending into said second support member from said second face and extending through said length of said second support member equidistant between the intersection of said second face and said first face and the intersection of said second face and said fourth face;
a plurality of first interlock brackets connected to and extending outwardly from said first edges and said second edges of said glazing panels, each of said first interlock brackets having an interlock extension to be received in sliding relation with one of said interlock grooves of one of said first support members, each of said first interlock brackets centered on said respective first and second edges of said glazing panels, and each of said first interlock brackets having a length less than said height “h” of said glazing panels; and
a plurality of second interlock brackets connected to and extending outwardly from said top edges and said bottom edges of said glazing panels, each of said second interlock brackets having an interlock extension to be received in sliding relation with one of said interlock grooves of one of said second support members, each of said second interlock brackets centered on said respective top and bottom edges of said glazing panels, and each of said second interlock brackets having a length less than said width “w” of said glazing panels.

2. The modular construction system of claim 1, wherein each of said first and said second interlock brackets includes a generally U-shaped channel extending in parallel opposed relation to said interlock extension, with one of said edges of one of said glazing panels received and connected within said channel of each said interlock bracket.

3. The modular construction system of claim 1, wherein each of said first support members and each of said second support members includes a third interlock groove extending into said support member from said third face, and a fourth interlock groove extending into said support member from said fourth face.

4. The modular construction system of claim 1, for forming a hexahedral greenhouse structure with an open bottom, wherein the number of said glazing panels is five, the number of said first support members is four, the number of said second support members is eight, the number of said first interlock brackets is ten, and the number of said second interlock brackets is ten.

5. The modular construction system of claim 1, further comprising a plurality of connector plates for releasably connecting adjacent ends of said support members during the formation of a greenhouse structure, each of said connector plates penetrated by a plurality of screw apertures for the extension of screws through said screw apertures and into said support members.

6. The modular construction system of claim 1, further comprising a plurality of connector brackets for releasably connecting adjacent ends of said support members during the formation of a greenhouse structure, each of said connector plates having three planar legs disposed to be received with one of said legs disposed against one of said faces of adjacent legs at each corner of the formed greenhouse structure, each of said legs penetrated by a plurality of screw apertures for the extension of screws through said screw apertures and into said support members.

7. The modular construction system of claim 1, further comprising,
a sliding glazing panel for forming a greenhouse structure with a sliding openable and closeable wall, said sliding glazing panel having a first edge, an second edge opposite from said first edge, a third edge perpendicular to said first and second edges, and a fourth edge opposite from said third edge, with one of said first interlock brackets connected to said first edge, with one of said first interlock brackets connected to said second edge, with one of said second interlock brackets connected to said fourth edge; and with one of said second support members engaged with said interlock extension of said second interlock bracket at said fourth edge of said sliding glazing panel;
a first sealing bracket connected to said third edge of said sliding glazing panel, said sealing bracket having a sealing extension extending parallel to and outwardly from said third edge to be received in one of said interlock grooves of one of said support members from one of said faces of said support member; and
a second sealing bracket having an interlock extension and a sealing strip parallel to said interlock extension, said second sealing bracket connected to said second support member at said fourth edge of said sliding glazing panel, with said sealing strip extending from said second support member perpendicular to said sliding glazing panel.

8. The modular construction system of claim 1, further including a bypass sliding door assembly, comprising,
a pair of planar door panels each having a first end and a second end, each being of height “h” equal to the height of said glazing panels, and each being of a width slightly greater than one half the width “w” of said glazing panels;
a first slider bracket being approximately equal in length to said first extension brackets, said first slider bracket having a pair of generally U-shaped channels extending longitudinally through the full length of said first slider bracket, each of said channels to receive said first end of one of said doors in sliding relation therein, and having an interlock extension extending longitudinally through the full length of said first slider bracket opposite said channels, said interlock extension to be received in said interlock groove of one of said first support members to be disposed above said door panels; and
a second slider bracket being approximately equal in length to said first extension brackets, said second slider bracket having a pair of generally U-shaped channels extending longitudinally through the full length of said second slider bracket, each of said channels to receive said second end of one of said doors in sliding relation therein, and having an interlock extension extending longitudinally through the full length of said first slider bracket opposite said channels, said interlock extension to be received in said interlock groove of another of said first support members to be disposed below said door panels.

9. The modular construction system of claim 1, further including a hinged door assembly, comprising,
a planar door panel having a first side edge, a second side edge, a top edge, and a bottom edge;
a hinge bracket connected to and extending along said first side edge of said door panel, said hinge bracket having a U-shaped channel to receive said first side edge of said door panel, an interlock extension to be received in one of said interlock grooves of one of said support members, and an elongate hinge connected between said channel and said interlock extension such that said channel, and said door panel connected within said channel, are pivotable relative to said interlock extension.

10. The modular construction system of claim 9, wherein the number of said door panels and the number of said hinge brackets is two, and wherein the width each of said door panels between said first side edge and said second side edge is approximately equal to one half of said width of said glazing panels.

11. The modular construction system of claim 1, further including a ventilation window assembly, comprising,
a short glazing panel of said width “w” and of a height less than said height “h” of said glazing panels, said short glazing panel having a first side edge, a second side edge, a top edge, and a bottom edge, and having one of said interlock brackets connected to said bottom edge of said short glazing panel;
a pair of short interlock brackets each having a generally U-shaped channel received over and connected to said first side edge and said second side edge, respectively, of said short glazing panel, and each having an interlock extension extending in parallel opposed relation to said channel;
a pair of sliding window panels, each having a first side edge, a second side edge, a top edge, and a bottom edge, each of said sliding window panels having a width between said first and second side edges greater than one half of said width “w” of said short glazing panel, and each of said window panels having a height slightly less than the difference between said height of said short glazing panel and said height “h” of said glazing panels;
a first slider bracket being approximately equal in length to said first extension brackets, said first slider bracket having a pair of generally U-shaped channels extending longitudinally through the fill length of said first slider bracket, each of said channels to receive said top edge of one of said window panels sliding relation therein, and having an interlock extension extending longitudinally through the full length of said first slider bracket opposite said channels, said interlock extension to be received in said interlock groove of one of said support members; and
a second slider bracket being approximately equal in length to said first slider bracket, said second slider bracket having a pair of generally U-shaped channels extending longitudinally through the full length of said second slider bracket, each of said channels to receive said bottom edge of one of said window panels sliding relation therein, and having a single U-shaped channel extending in parallel opposed relation to said pair of channels, said single channel received over and interconnected to said top edge of said short glazing panel.

12. The modular construction system of claim 1, wherein one of said glazing panels includes a pass-through aperture formed in said glazing panel between said edges of said glazing panel to receive an elongate object therethrough, and a grommet disposed in said aperture and connected to said glazing panel around said aperture, said grommet having a self-closing central web formed of a flexible shape retentive material with a slit formed therein.

13. The modular construction system of claim 1, wherein one of said glazing panels includes a rectangular pass-through aperture formed in said glazing panel between said edges of said glazing panel to receive an elongate object therethrough, said aperture having a first side edge, a second side edge, a top edge, and a bottom edge, and an aperture seal having a first set of flexible bristles connected to said first side edge of said aperture and extending across said aperture toward said second edge, and a second set of flexible bristles connected to said second side edge of said aperture and extending across said aperture toward said first edge, with said first set of bristles and said second set of bristles in overlapping intermixed relation to each other.

14. The modular construction system of claim 1, wherein each of said glazing panels is of single pane construction.

15. The modular construction system of claim 1, wherein each of said glazing panels is of double pane construction, each of said glazing panels including a first pane and a second pane, each having a first edge, a second edge, a third edge, and a fourth edge, said first and second panes disposed in overlying parallel relation with a space between said panes, and a plurality of spacers connected between said first pane and said second pane along said respective edges of said panes.

16. A modular construction system for forming a greenhouse structure with a bypass sliding door, comprising
a plurality of planar glazing panels each having a first side edge, a second side edge opposite said first side edge, a top edge, and a bottom edge opposite said top edge, and each being of width “w” between said first and second side edges and of height “h” between said top edge and said bottom edge;
a pair of planar door panels each having a first end and a second end, each being of height “h” equal to the height of said glazing panels, and each being of a width slightly greater than one half the width “w” of said glazing panels;
a plurality of first support members for connecting and supporting said glazing panels, each of said first support members having a first end and a second end, and having a first face, a second face adjacent to said first face, a third face opposite said first face, and a fourth face opposite said second face, each of said first support members being of thickness “t” between said first face and said third face and between said second face and said fourth face, each of said first support members having a first longitudinal interlock groove extending into said first support member from said first face and extending through said length of said first support member equidistant between the intersection of said first face and said second face and the intersection of said first face and said third face, and a second interlock groove extending into said first support member from said second face and extending through said length of said first support member equidistant between the intersection of said second face and said first face and the intersection of said second face and said fourth face;
a plurality of second support members for connecting and supporting said glazing panels, each of said second support members having a first end and a second end, and having a first face, a second face adjacent to said first face, a third face opposite said first face, and a fourth face opposite said second face, each of said second support members being of thickness “t” between said first face and said third face and between said second face and said fourth face equal to said thickness of said first support members, each of said second support members being of a length equal to the length of said first support members less twice said thickness “t”, each of said first support members having a first longitudinal interlock groove extending into said second support member from said first face and extending through said length of said second support member equidistant between the intersection of said first face and said second face and the intersection of said first face and said third face, and a second interlock groove extending into said second support member from said second face and extending through said length of said second support member equidistant between the intersection of said second face and said first face and the intersection of said second face and said fourth face;
first interlock means extending along said first edges and said second edges of said glazing panels, each to be received in one of said interlock grooves of one of said first support members;
second interlock means extending along said top edges and said bottom edges of said glazing panels, each to be received in one of said interlock grooves of one of said second support members;
a first slider bracket having a pair of generally U-shaped channels extending longitudinally through the full length of said first slider bracket, each of said channels to receive said first end of one of said doors in sliding relation therein, and having an interlock extension extending longitudinally through the full length of said first slider bracket opposite said channels, said interlock extension to be received in said interlock groove of one of said first support members to be disposed above said door panels; and
a second slider bracket having a pair of generally U-shaped channels extending longitudinally through the full length of said second slider bracket, each of said channels to receive said second end of one of said doors in sliding relation therein, and having an interlock extension extending longitudinally through the full length of said first slider bracket opposite said channels, said interlock extension to be received in said interlock groove of another of said first support members to be disposed below said door panels.

17. The modular construction system of claim 16, wherein said first interlock means comprises said first and second edges of said glazing panels, and wherein said second interlock means comprises said top and bottom edges of said glazing panels.

18. The modular construction system of claim 16, wherein each of said first and second interlock means comprises an elongate generally U-shaped channel received over and connected to a respective one of said edges of one of said glazing panels, and an interlock extension extending outwardly from said channel and said glazing panel parallel to said plane of said glazing panel, to be received in one of said interlock grooves of one of said support members.

19. The modular construction system of claim 16, further including a ventilation window assembly, comprising,
a short glazing panel of said width “w” and of a height less than said height “h” of said glazing panels, said short glazing panel having a first side edge, a second side edge, a top edge, and a bottom edge, and having said interlock means at said first and second side edges and at said bottom edge of said short glazing panel;
a pair of sliding window panels, each having a first side edge, a second side edge, a top edge, and a bottom edge, each of said sliding window panels having a width between said first and second side edges greater than one half of said width “w” of said short glazing panel, and each of said window panels having a height slightly less than the difference between said height of said short glazing panel and said height “h” of said glazing panels;
a first window slider bracket having a pair of generally U-shaped channels extending longitudinally through the full length of said first window slider bracket, each of said channels to receive said top edge of one of said window panels sliding relation therein, and having an interlock extension extending longitudinally through the full length of said first window slider bracket opposite said channels, said interlock extension to be received in said interlock groove of one of said support members; and
a second window slider bracket being approximately equal in length to said first slider bracket, said second window slider bracket having a pair of generally U-shaped channels extending longitudinally through the full length of said second window slider bracket, each of said channels to receive said bottom edge of one of said window panels sliding relation therein, and having a single U-shaped channel extending in parallel opposed relation to said pair of channels, said single channel received over and interconnected to said top edge of said short glazing panel.

20. The modular construction system of claim 19, wherein one of said window panels includes a self-closing pass-through aperture for removably receiving an elongate object therethrough.
